(19) United States
(12) Patent Application Publication
(10) Pub. No.: US 2026/0312279 A1
(43) Pub. Date: Oct. 8, 2026

(54) RADIO WAVE ABSORBER

(71) Applicants: DENSO CORPORATION, Kariya-shi (JP); TOYOTA JIDOSHA KABUSHIKI KAISHA, Toyota-shi (JP); MIRISE Technologies Corporation, Nisshin-shi (JP)

(72) Inventor: Takuya NAKAMURA, Nisshin-shi (JP)

(21) Appl. No.: 19/544,308

(22) Filed: Feb. 19, 2026

(30) Foreign Application Priority Data
Apr. 8, 2025 (JP) 2025-063755

(51) Int. Cl. H01Q 1/32; G01S 13/931; H01Q 13/06

(52) U.S. Cl. CPC H01Q 1/3233; G01S 13/931; H01Q 13/06

(57) ABSTRACT

A radio wave absorber includes a conductor layer as a first conductor, a dielectric layer, and a pattern layer as a second conductor. The dielectric layer includes one or more dielectric members. The pattern layer has conductor patterns arranged regularly. The conductor layer, the dielectric layer, and the pattern layer are sequentially stacked in a stacking direction such that the dielectric layer is interposed between the conductor layer and the pattern layer. The second conductor includes a conductive portion which is electrically conductive. The dielectric layer includes a conductor-overlapping portion that is overlapped with the conductive portion in the stacking direction, and a non-overlapping portion that is not overlapped with the conductive portion in the stacking direction. The dielectric layer has different path-lengths for radio waves in the stacking direction between the conductor-overlapping portion and the non-overlapping portion.

### CROSS REFERENCE TO RELATED APPLICATION

The present application claims the benefit of priority from Japanese Patent Application No. 2025-063755 filed on Apr. 8, 2025. The entire disclosure of the above application is incorporated herein by reference.

### TECHNICAL FIELD

The present disclosure relates to a radio wave absorber.

### BACKGROUND

Conventionally, radar devices mounted on vehicles are known as sensors for detecting obstacles.

### SUMMARY

A radio wave absorber includes a conductor layer as a first conductor, a dielectric layer, and a pattern layer as a second conductor. The dielectric layer includes one or more dielectric members. The pattern layer has conductor patterns arranged regularly. The conductor layer, the dielectric layer, and the pattern layer are sequentially stacked in a stacking direction such that the dielectric layer is interposed between the conductor layer and the pattern layer. The second conductor includes a conductive portion which is electrically conductive. The dielectric layer includes a conductor-overlapping portion that is overlapped with the conductive portion in the stacking direction, and a non-overlapping portion that is not overlapped with the conductive portion in the stacking direction. The dielectric layer has different path-lengths for radio waves in the stacking direction between the conductor-overlapping portion and the non-overlapping portion.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic perspective view of a radio wave absorber according to an embodiment.

FIG. 2 is a schematic cross-sectional view of the radio wave absorber according to the embodiment.

FIG. 3 is a schematic perspective view of a part of the radio wave absorber according to the embodiment.

FIG. 4 is a schematic cross-sectional view of the radio wave absorber shown in FIG. 3, cut along a stacking direction.

FIG. 5 is an explanatory diagram illustrating wavelengths of radio waves in the radio wave absorber.

FIG. 6 is an explanatory diagram illustrating an operating frequency in the radio wave absorber.

FIG. 7 is a schematic cross-sectional view of a radio wave absorber according to a first modification.

FIG. 8 is schematic a perspective view of a radio wave absorber according to a second modification.

FIG. 9 is a schematic cross-sectional view of the radio wave absorber according to the second modification.

FIG. 10 is a schematic perspective view of a radio wave absorber according to a third modification.

FIG. 11 is a schematic cross-sectional view of the radio wave absorber according to the third modification.

FIG. 12 is a schematic cross-sectional view of a radio wave absorber according to a fourth modification.

### DETAILED DESCRIPTION

To begin with, examples of relevant techniques will be described. According to a comparative example, radar devices mounted on vehicles are known as sensors for detecting obstacles. When a radar device is mounted on a vehicle, radio waves that undergo multiple reflections between a radar substrate and a bumper, and radio waves that undergo multiple reflections between a radome and the bumper, may interfere with original transmission and reception signals of the radar device. Such radio wave interference can cause degradation in performance of the radar device, such as a maximum detection range and direction estimation accuracy. In recent years, advancements in processing technology increases cases where a resin waveguide antenna including an antenna section and waveguide using a metal-coated resin structure is disposed on the radar substrate. As a result, countermeasures against reflections have attracted attention.

For example, a countermeasure is to use a radio wave absorber made by sequentially laminating a conductor layer made of a conductor, a dielectric layer made of a dielectric member, and a pattern layer having a predetermined conductor pattern, as described in the comparative example. The comparative example describes a technique for broadening a frequency band in which radio wave attenuation-characteristics can be obtained by varying a size and other aspects of adjacent conductor patterns. The above-described countermeasures against reflections can be achieved by applying the technique described in the comparative example to the metal-coated resin waveguide antenna.

When a structure in which conductor patterns of different sizes are provided in a pattern layer is adopted as in the comparative example, dead space areas are increased. As a result, the structure can not function without securing a sufficiently large area in the pattern layer. This leads to an increase in the size of the radio wave absorber, which may become a factor that hinders an application of the radio wave absorber to a compact radar device.

In contrast to the comparative example, according to the present disclosure, a radio wave absorber is capable of achieving a broad frequency band in which radio wave attenuation-characteristics can be obtained, while reducing an increase in size.

According to an aspect of the present disclosure, a radio wave absorber includes a conductor layer as a first conductor, a dielectric layer, and a pattern layer as a second conductor. The dielectric layer includes one or more dielectric members. The pattern layer has conductor patterns arranged regularly. The conductor layer, the dielectric layer, and the pattern layer are sequentially stacked in a stacking direction such that the dielectric layer is interposed between the conductor layer and the pattern layer. The second conductor includes a conductive portion which is electrically conductive. The dielectric layer includes a conductor-overlapping portion that is overlapped with the conductive portion in the stacking direction, and a non-overlapping portion that is not overlapped with the conductive portion in the stacking direction. The dielectric layer has different path-lengths for radio waves in the stacking direction between the conductor-overlapping portion and the non-overlapping portion.

Thus, the dielectric layer, configured so that the path-lengths for radio waves are different between the non-overlapping portions and the conductor overlapping portions, can generate multiple resonance frequencies that are relatively close to each other without the conductor patterns having various sizes or shapes in the pattern layer. Accordingly, the radio wave absorber of the present disclosure can achieve a broad frequency band in which the attenuation characteristics of radio waves are obtained, while reducing an increase in size of the radio wave absorber.

The embodiments of the present disclosure will be described below with reference to the drawings. In the following embodiments, portions that are the same as or equivalent to those described in a preceding embodiment are denoted by the same reference numerals, and a description of the same or equivalent portions may be omitted. When only some of the configuration elements are described in the embodiment, the remaining configuration elements can be referred from those described in the preceding embodiment. The following embodiments may be partially combined with each other even if such a combination is not explicitly described as long as there is no disadvantage with respect to such a combination.

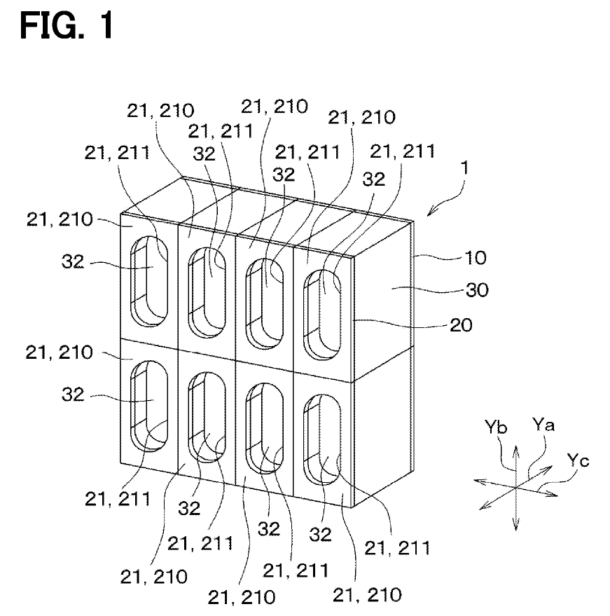

Hereinafter, an embodiment of the present disclosure will be described with reference to FIGS. 1 to 6. In the present embodiment, an example in which a radio wave absorber 1 of the present disclosure is applied to an in-vehicle radar device for detecting obstacles and the like present around a vehicle will be described.

The in-vehicle radar device transmits radio waves (for example, millimeter waves) toward an object and receives radio waves reflected by the object as reflected waves, thereby acquiring information about the object such as a distance to the object, a position of the object, and a shape of the object. The in-vehicle radar device is used, for example, to measure a distance and relative speed between a vehicle and a preceding vehicle for performing adaptive cruise control (i.e., ACC) and automatic braking systems. The in-vehicle radar device is installed, for example, behind a vehicle bumper.

The radio wave absorber 1 is provided together with a resin waveguide antenna (not shown) arranged on the radar substrate. The radio wave absorber 1 can reduce multiple reflections that occur between the radar substrate and the bumper by absorbing radio waves that has reflected from areas other than an antenna slot for the resin waveguide antenna arranged on the radar substrate. Here, the resin waveguide antenna is formed of laminated multiple structures in which resin is coated with metal, and thereby includes an antenna (i.e., horn antenna or slit antenna) and a waveguide for routing signals (i.e., radio waves) from a radar IC. The radio wave absorber 1 of the present embodiment is configured as an integral structure with the resin waveguide antenna.

As shown in FIG. 1, the radio wave absorber 1 includes a conductor layer 10, a pattern layer 20, and a dielectric layer 30. The conductor layer 10, the pattern layer 20, and the dielectric layer 30 are sequentially laminated in the radio wave absorber 1 such that the dielectric layer 30 is interposed between the conductor layer 10 and the pattern layer 20.

In this embodiment, a stacking direction of the conductor layer 10, the pattern layer 20, and the dielectric layer 30 is referred to as a thickness direction Ya. One direction on a plane perpendicular to the thickness direction Ya is referred to as a vertical direction Yb, and a direction perpendicular to both the thickness direction Ya and the vertical direction Yb is referred to as a horizontal direction Yc.

The conductor layer 10 constitutes a rear surface of the radio wave absorber 1. The conductor layer 10 is made of a first conductor having electrical conductivity. The conductor layer 10 is made, for example, of a metal material having excellent electrical conductivity, such as copper or silver.

The pattern layer 20 constitutes a front surface of the radio wave absorber 1. The pattern layer 20 is made of a second conductor having electrical conductivity. The pattern layer 20 is made, for example, of a metal material having excellent electrical conductivity, such as copper or silver. The pattern layer 20 may be made of the same metal material as the conductor layer 10, or may be made of a different metal material.

Multiple conductor patterns 21 are regularly provided on the pattern layer 20. Each conductor pattern 21 is a pattern in which an opening portion 211 is provided approximately at a center of a rectangular conductive portion 210. Specifically, the conductive portion 210 has a long side extending in the vertical direction Yb and a short side extending in the horizontal direction Yc. Furthermore, the opening portion 211 has an ellipse shape with its major diameter extending in the vertical direction Yb and its minor diameter extending along the horizontal direction Yc.

The multiple conductor patterns 21 having the same shape are arranged in a matrix on the same plane of the pattern layer 20. In other words, the pattern layer 20 has the multiple conductor patterns 21 having the same shape and arranged regularly in both the vertical direction Yb and the horizontal direction Yc, thereby constituting a "periodic pattern" with electrical conductivity.

The dielectric layer 30 is disposed between the conductor layer 10 and the pattern layer 20. The dielectric layer 30 attenuates radio waves by converting the radio waves incident from the pattern layer 20 into heat through dielectric loss. The dielectric layer 30 is made of a resin material having dielectric loss, such as polyphenylene sulfide (i.e., PPS), for example.

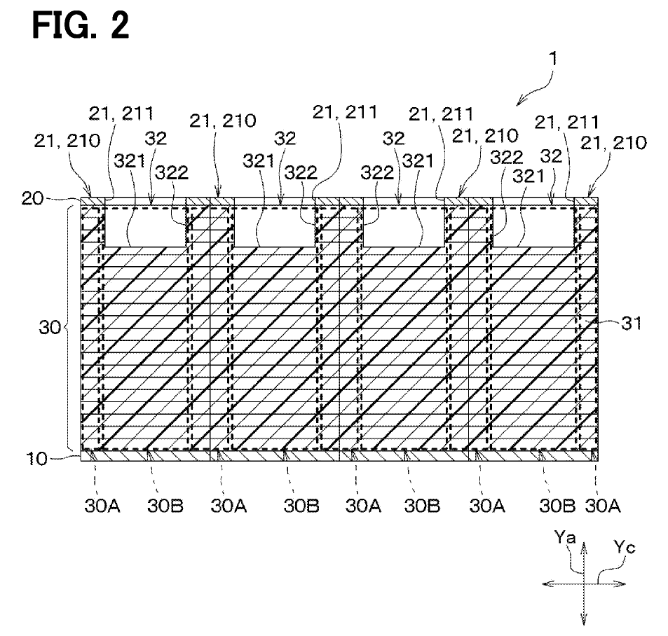

As shown in FIG. 2, the dielectric layer 30 includes multilayer structure in which a large number of dielectric members 31 are stacked. Among the large number of dielectric members 31, at least multiple dielectric members 31 adjacent to the conductor layer 10 or the pattern layer 20 are made of a resin material capable of adhering to the first conductor of the conductor layer 10 or the second conductor of the pattern layer 20. For convenience, a reference numeral "31" is assigned to only one of the multiple dielectric members 31 in FIG. 2 and the like.

The dielectric layer 30 includes conductor-overlapping portions 30A that overlap with the conductive portions 210 of the conductor patterns 21 in the stacking direction, and non-overlapping portions 30B that do not overlap with the conductive portions 210 of the conductor patterns 21 in the stacking direction. Specifically, the conductor-overlapping portions 30A are portions of the dielectric layer 30 that are overlapped with the conductive portions 210 of the conductor patterns 21 in the stacking direction. The non-overlapping portions 30B are portions of the dielectric layer 30 that are not overlapped with the conductive portions 210 of the conductor patterns 21 in the stacking direction. In other words, the non-overlapping portions 30B are portions of the dielectric layer 30 that face opening portions 211 of the conductor patterns 21 in the stacking direction.

The dielectric layer 30 has different path-lengths for radio waves in the stacking direction between the conductor-overlapping portions 30A and the non-overlapping portions 30B. Specifically, at least one of the multiple dielectric members 31 closest to the pattern layer 20 has a regular shape similar to that of the conductor pattern 21, in the dielectric layer 30. In other words, the at least one dielectric member 31 of the multiple dielectric members 31 closest to the pattern layer 20 include openings having ellipse shapes at locations that overlap with the opening portion 211 of the conductor pattern 21 in the stacking direction. As a result, the opening in each dielectric member 31 constitutes groove portions 32 that are recessed from the pattern layer 20 toward the conductor layer 10 in the stacking direction, and the groove portions 32 are located in the non-overlapping portions 30B of the dielectric layer 30.

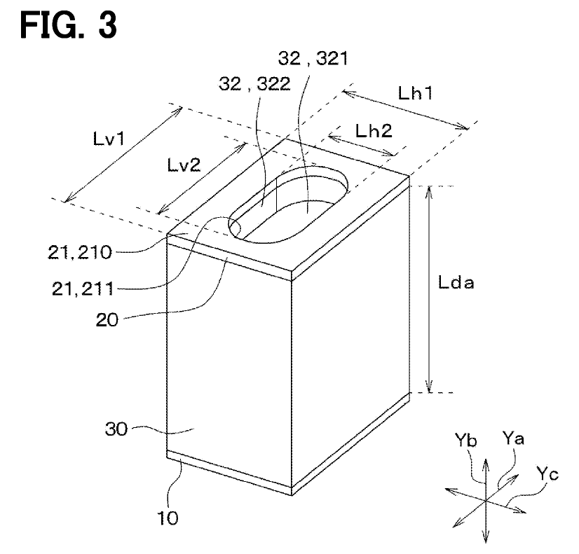

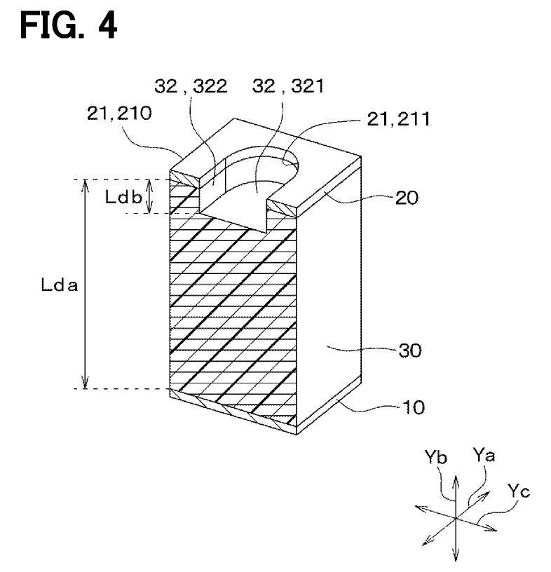

In the dielectric layer 30, a depth of the groove portions 32 in the stacking direction is shorter than a half of an overall thickness Lda of the dielectric layer 30 in the stacking direction. The groove portions 32 have bottom surfaces 321 that extend in a direction perpendicular to the stacking direction, and side surfaces 322 that extends in the stacking direction. The bottom surfaces 321 of the groove portions 32 have the same shapes as the opening portions 211 of the conductor patterns 21. Hereinafter, details of the conductor patterns 21 and the groove portions 32 of the present embodiment will be described with reference to FIGS. 3 and 4.

The pattern layer 20 forms the "periodic pattern" through periodic arrangement of the conductor pattern 21 shown in FIG. 3. As shown in FIGS. 3 and 4, the conductor pattern 21 includes the conductive portion 210 having a rectangular shape, and an opening portion 211 having an elliptical shape. For example, the conductive portion 210 has a long side 210a with a dimension Lv1 of "2.95 mm," and a short side with a dimension Lh1 of "1.85 mm", in the conductor pattern 21. In addition, for example, the opening portion 211 has a major diameter with a dimension Lv2 of "2.14 mm" and a minor diameter with a dimension Lh2 of "1.00 mm". When each dimension is converted based on a wavelength λ of radio wave (λ is approximately 4 mm in this example), the dimension becomes "Lv1 ≈ 0.74λ," "Lh1 ≈ 0.46λ", "Lv2 ≈ 0.54λ", and "Lh2 ≈ 0.25λ," respectively.

A groove portion 32 of the dielectric layer 30 includes a bottom surface 321 having an elliptical shape similar to the opening portion 211 of the conductor pattern 21. The groove portion 32 has the depth Ldb in the stacking direction that is smaller than a half of the overall thickness Lda of the dielectric layer 30 in the stacking direction. For example, the depth Ldb of the groove portion 32 in the stacking direction is "0.4 mm". Furthermore, the overall thickness Lda of the dielectric layer 30 in the stacking direction is "2.84 mm", for example. When each dimension is converted based on the wavelength λ of the radio wave (λ is approximately 4 mm in this example), the dimension becomes "Lda ≈ 0.71λ" and "Ldb ≈ 0.1λ", respectively.

For example, the groove portion 32 can be created by removing a portion of the dielectric members 31 directly beneath the conductor pattern 21 by cutting or the like when the conductor pattern 21 that has a suitable shape is formed on the pattern layer 20.

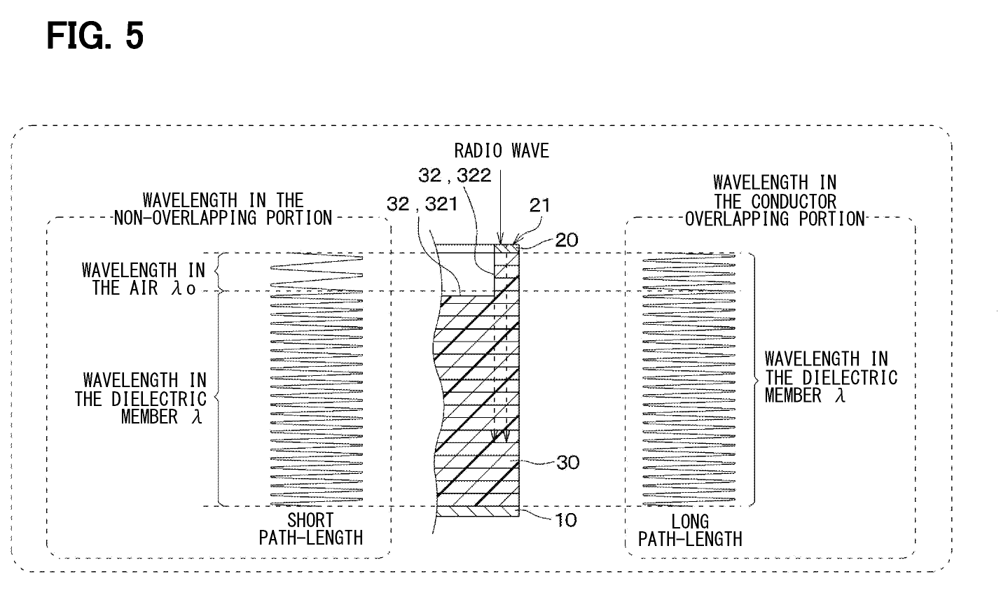

An operation of the radio wave absorber 1 configured as described above will be explained with reference to FIG. 5. When the radio wave absorber 1 receives radio waves from the outside, the radio waves are incident on the pattern layer 20. In a region from the pattern layer 20 to a conductor-overlapping portion 30A, the radio waves go through the conductor pattern 21, the dielectric members 31, and the conductor layer 10, in this order. On the other hand, in a region from the pattern layer 20 to the non-overlapping portion 30B, the radio waves go through the conductor pattern 21, the groove portion 32, the dielectric members 31, and the conductor layer 10, in this order. The groove portion 32 is an air layer without the dielectric members 31. The radio waves includes a wavelength λo in the air layer and the wavelength λ in the dielectric members 31. The wavelength λo is longer than the wavelength λ. As a result, a path-length for radio wave in the non-overlapping portion 30B is shorter than a path-length for radio wave in the conductor-overlapping portion 30A.

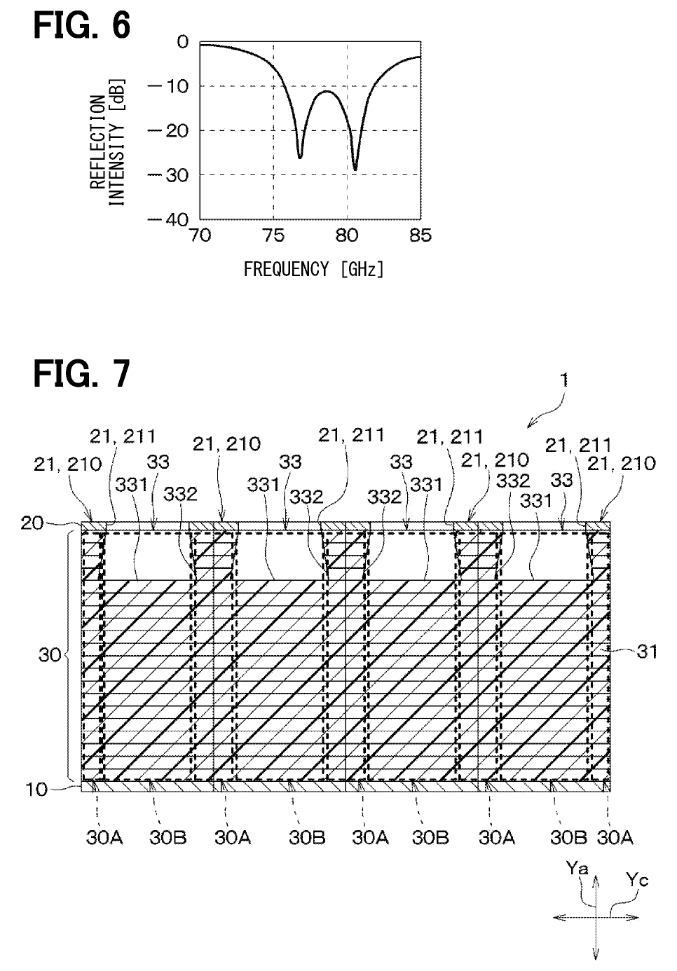

As described above, since the radio wave absorber 1 is configured to make difference in the path-lengths for radio waves, the radio wave absorber 1 has a structure in which multiple resonance points are generated along the stacking direction. For example, in this structure, as shown in FIG. 6, operating frequencies (i.e., resonance frequencies) increase to two points, thereby broadening an operating frequency band.

The radio wave absorber 1 described above is configured so that the non-overlapping portions 30B of the dielectric layer 30 are different in the path-lengths for radio waves in the stacking direction from the conductor-overlapping portions 30A. Thus, the dielectric layer 30, configured so that the path-lengths for radio waves are different between the non-overlapping portions 30B and the conductor-overlapping portions 30A, can generate multiple resonance frequencies that are relatively close to each other without the conductor patterns 21 having various sizes or shapes in the pattern layer 20. Accordingly, the radio wave absorber 1 of the present embodiment can achieve a broad frequency band in which the attenuation characteristics of radio waves are obtained, while reducing an increase in size of the radio wave absorber 1. Radar devices may include a patch antenna made by routing wirings on the radar substrate according to a printed pattern. In this case, an attenuation of the radio waves may occur in wiring routing sections. In contrast, a resin waveguide antenna, in which multiple metal-coated resin structures are stacked together, can reduce the attenuation caused by the wirings and the like. However, since a surface of the resin waveguide antenna is a metal-coated layer exposed to an outside, the radio waves are likely to be reflected on portions other than those that function as the antenna (e.g., antenna slot), similarly to on the radar substrate. In consideration of the above, the radio wave absorber 1 is disposed together with the resin waveguide antenna on the radar substrate. Accordingly, the radio wave absorber 1 can reduce multiple reflections that occur between the radar substrate and the bumper, by absorbing radio waves that have been reflected from areas other than the antenna slot of the resin waveguide antenna. In particular, the radio wave absorber 1 of the present embodiment may be suited for the resin waveguide antenna. This is because the radio wave absorber 1 has the same layered structure as that of the resin waveguide antenna, in which a metal-coated layer, a resin layer, and the metal-coated layer are stacked in this order. As a result, the radio wave absorber 1 is relatively easily disposed in an available space together with the resin waveguide antenna. For example, the radio wave absorber 1 can be disposed in the resin waveguide antenna by forming the conductor pattern 21 on a surface of the metal-coated layer that is an unused area of the resin waveguide antenna, and providing a step corresponding to the groove portion 32 on the resin layer that is the unused area.

Furthermore, the radio wave absorber 1 of the present embodiment has the following features. (1) The dielectric layer 30 includes the groove portion 32, which is recessed from the pattern layer 20 toward the conductor layer 10 in the stacking direction, in the non-overlapping portion 30B. Accordingly, a simple structure in which the groove portion 32 is disposed in the non-overlapping portion 30B can generate multiple resonant frequencies that are relatively close to each other. In particular, since the shape of the dielectric layer 30 varies in the stacking direction, an increase in size of the radio wave absorber 1 can be reduced compared to cases where the size or shape of the conductor pattern 21 is changed.

(2) The dielectric layer 30 is made by laminating the multiple dielectric members 31. Among the multiple dielectric members 31, at least the one closest to the pattern layer 20 has the regular shape similar to that of the conductor pattern 21. As described above, when the at least one dielectric member 31 that is close to the pattern layer 20 has the regular shape similar to that of the conductor pattern 21, the conductor pattern 21 can be properly attached to the dielectric layer 30.

(3) In the dielectric layer 30, the depth Ldb of the groove portion 32 in the stacking direction is less than the half of the overall thickness Lda of the dielectric layer 30 in the stacking direction. Accordingly, this dielectric layer 30 may easily generate the multiple resonance frequencies that are relatively close to each other.

### First Modification

The dielectric layer 30 of the above-described embodiment includes a side surface 322 of the groove portion 32 that extends in the stacking direction, but it is not limited to this. For example, the dielectric layer 30 may include side surfaces 332 of a groove portion 33 that are inclined with respect to the stacking direction, as shown in FIG. 7. In the groove portion 33 shown in FIG. 7, the side surfaces 332 are inclined with respect to the stacking direction such that a portion of the groove portion 33 which recesses to the conductor-overlapping portion 30A increases in a direction from the pattern layer 20 toward the conductor layer 10. In the groove portion 33 shown in FIG. 7, its bottom surface 331 is larger than the opening portion 211 of the conductor pattern 21.

The radio wave absorber 1 of this above-described modification provides an air layer in a portion of the conductor-overlapping portion 30A by the side surfaces 332 of the groove portion 33 being inclined with respect to the stacking direction. As a result, the path-lengths for radio waves in the part of the conductor-overlapping portion 30A can be short, and the difference in the path-lengths for radio waves between the non-overlapping portion 30B of the dielectric layer 30 and the conductor-overlapping portion 30A can be properly adjusted.

### Second Modification

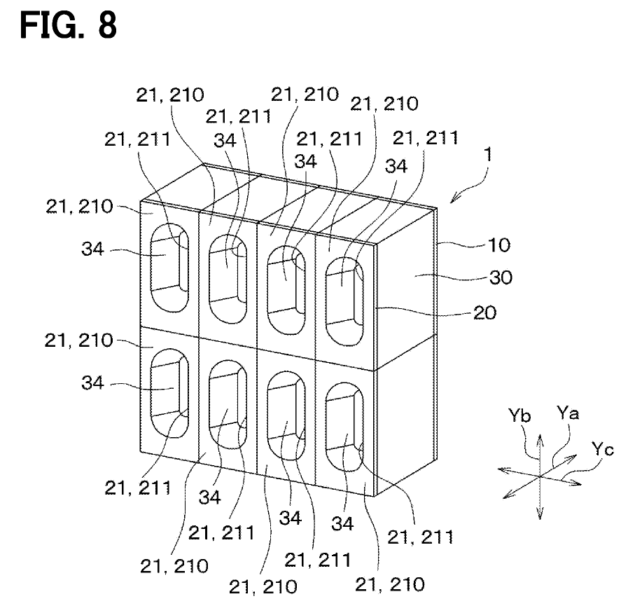

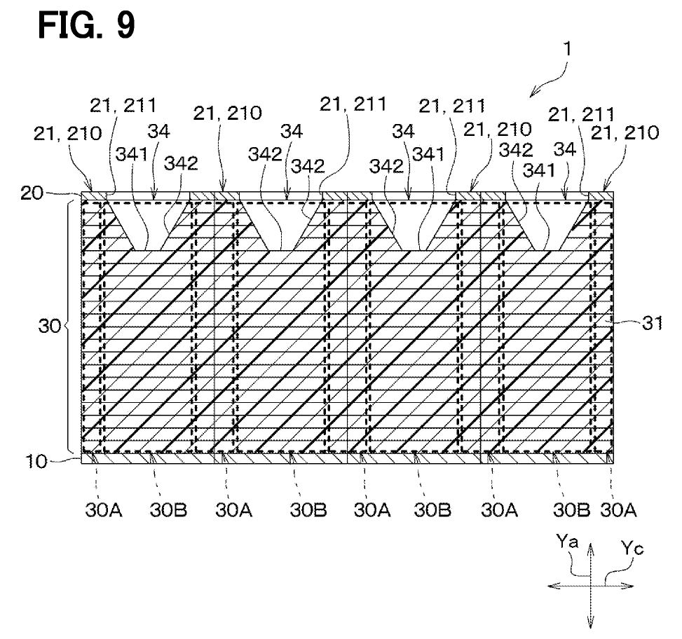

Furthermore, in the dielectric layer 30 shown in FIGS. 8 and 9, side surfaces 342 of a groove portion 34 may be inclined with respect to the stacking direction such that a distance (i.e., groove width) between opposite side surfaces 342 decreases in a direction from the pattern layer 20 toward the conductor layer 10. A bottom surface 341 of the groove portion 34 shown in FIG. 8 is smaller than the opening portion 211 of the conductor pattern 21.

The radio wave absorber 1 of this above-described modification can properly adjust the difference in the path-lengths for radio waves between the non-overlapping portion 30B of the dielectric layer 30 and the conductor-overlapping portion 30A, by the side surfaces 342 of the groove portion 34 being inclined with respect to the stacking direction.

### Third Modification

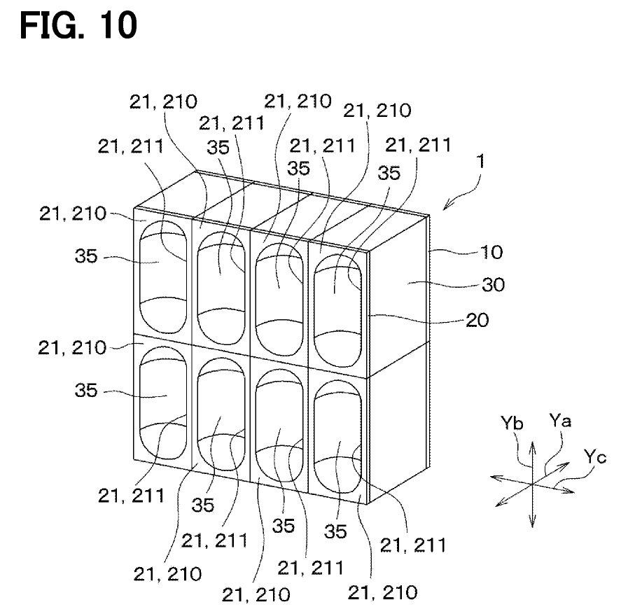

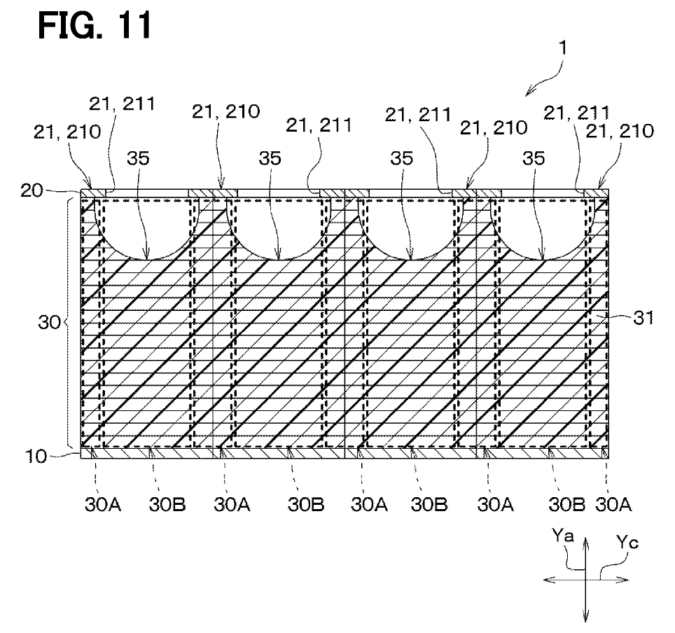

Furthermore, the dielectric layer 30 may include a side surface 351 of a groove portion 35 that is curved surface, as shown in FIGS. 10 and 11. The side surface 351 of the groove portion 35 is curved in an arc shape recessed from the pattern layer 20 toward the conductor layer 10. The radio wave absorber 1 of this above-described modification can properly adjust the difference in the path-lengths for radio waves between the non-overlapping portion 30B of the dielectric layer 30 and the conductor-overlapping portion 30A, by the side surface 351 being curved.

### Fourth Modification

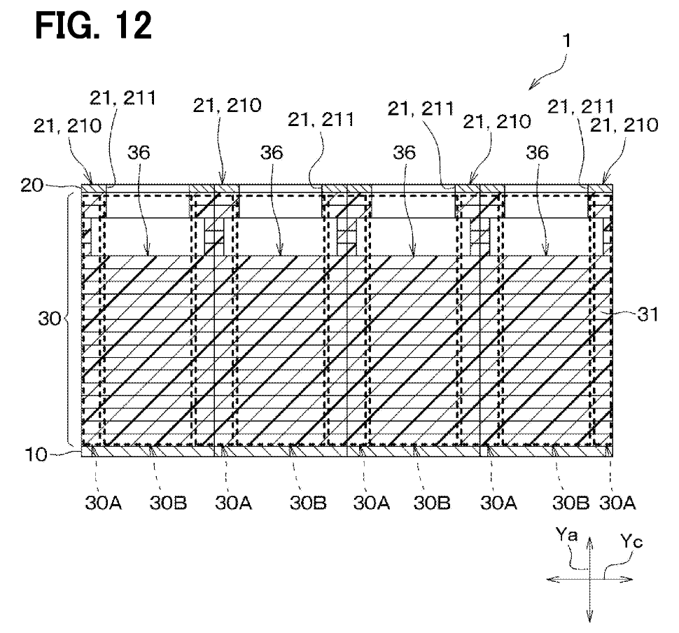

Furthermore, the dielectric layer 30 may include a portion where a groove width of a groove portion 36 increases in the stacking direction from the pattern layer 20 toward the conductor layer 10, as shown in FIG. 12. The radio wave absorber 1 of this above-described modification can properly adjust the difference in the path-lengths for radio waves between the non-overlapping portion 30B of the dielectric layer 30 and the conductor-overlapping portion 30A, by a shape of the groove portion 36 having the various groove width.

### Other Embodiments

The representative embodiment of the present disclosure has been described above. However, the present disclosure is not limited to the embodiment described above and may be variously modified as follows.

The radio wave absorber 1 of the above-described embodiment includes the groove portion 32 adjacent to the pattern layer 20 within the non-overlapping portions 30B of the dielectric layer 30. However, this is not limited this. For example, the groove portion 32 may be adjacent to the conductor layer 10.

For example, the radio wave absorber 1 may include a hollow portion in the non-overlapping portion 30B of the dielectric layer 30 instead of the groove portion 32, so that the path-length for radio wave in at least a part of the non-overlapping portion 30B is different from that in the conductor-overlapping portion 30A. Furthermore, the radio wave absorber 1 may partially adopt a resin material having a different dielectric constant from that of the non-overlapping portion 30B of the dielectric layer 30, so that the path-length for radio wave in at least a part of the non-overlapping portion 30B is different from that in the conductor-overlapping portion 30A.

In the above-described embodiment, the conductor pattern 21 having the elliptical opening portion 211 has been exemplified. However, the conductor pattern 21 is not limited to the above-described example. The shape of the conductor pattern 21 may be different from that described above.

In the above embodiment, the dielectric layer 30 in which a large number of the dielectric members 31 are stacked in the stacking direction has been exemplified. However, the dielectric layer 30 is not limited to the above-described example. The dielectric layer 30 may be made of a single dielectric member 31.

In the above embodiments, an example in which the radio wave absorber 1 of the present disclosure is applied to an in-vehicle radar device has been exemplified. However, the application of the radio wave absorber 1 is not limited to this. The radio wave absorber 1 can also be applied to devices other than in-vehicle radar devices. The radio wave absorber 1 may be provided in a radome that accommodates the radar substrate. In this case, the radio wave absorber 1 can absorb the radio waves that have undergone multiple reflections between the radar substrate and the bumper, and the radio waves that have undergone multiple reflections between the radome and the bumper, as unnecessary radio waves.

In the above embodiment, it goes without saying that the constituent elements of the embodiment are not necessarily essential except in cases where they are expressly indicated to be essential or are considered to be obviously essential in principle.

In the above embodiment, when the numbers, values, quantities, ranges, or the like of the components of the embodiment are mentioned, the present disclosure is not limited to such specific numbers except in cases where they are expressly indicated to be essential or are obviously limited to specific numbers in principle.

In the above embodiment, references to the shape or positional relationship of components, and the like, are not limited to those shapes or positional relationships unless expressly specified as essential or obviously limited to particular shapes or positional relationships in principle.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A radio wave absorber comprising:
a conductor layer as a first conductor;
a dielectric layer including one or more dielectric members; and
a pattern layer, as a second conductor, having conductor patterns arranged regularly, wherein
the conductor layer, the dielectric layer, and the pattern layer are sequentially stacked in a stacking direction such that the dielectric layer is interposed between the conductor layer and the pattern layer,
the second conductor includes a conductive portion which is electrically conductive,
the dielectric layer includes:
a conductor-overlapping portion that is overlapped with the conductive portion in the stacking direction; and
a non-overlapping portion that is not overlapped with the conductive portion in the stacking direction, and
the dielectric layer has different path-lengths for radio waves in the stacking direction between the conductor-overlapping portion and the non-overlapping portion.

2. The radio wave absorber according to claim 1, wherein
the non-overlapping portion includes a groove portion recessed from the pattern layer toward the conductor layer in the stacking direction.

3. The radio wave absorber according to claim 1, wherein
the one or more dielectric members are dielectric members stacked in the dielectric layer, and
at least one of the dielectric members that is closest to the pattern layer has a regular shape corresponding to regular arrangement of the conductor patterns.

4. The radio wave absorber according to claim 2, wherein
the groove portion of the dielectric layer has a side surface that is inclined with respect to the stacking direction.

5. The radio wave absorber according to claim 2, wherein
the groove portion of the dielectric layer has a side surface that is curved.

6. The radio wave absorber according to claim 2, wherein
the groove portion includes a portion in which a groove width increases in the stacking direction from the pattern layer toward the conductor layer.

7. The radio wave absorber according to claim 2, wherein
the groove portion of the dielectric layer has a depth in the stacking direction, which is smaller than a half of an overall thickness of the dielectric layer in the stacking direction.

8. The radio wave absorber according to claim 2, wherein
the groove portion includes a portion in which a groove width decreases in the stacking direction from the pattern layer toward the conductor layer.

9. The radio wave absorber according to claim 1, wherein
the pattern layer has openings regularly arranged, and
the non-overlapping portion is exposed from the openings to an outside of the radio wave absorber.
